(19) United States
(12) Patent Application Publication
(10) Pub. No.: US 2008/0118896 A1
(43) Pub. Date: May 22, 2008

(54) Cube with patterned designs and use of the cube for generating pattern matching configurations

(76) Inventor: Pablo Cha, Los Angeles, CA (US)

Correspondence Address: TY UNG, 16830 VENTURA BLVD., SUITE 360, ENCINO, CA, 91436, US

(21) Appl. No.: 12/009,394

(22) Filed: Jan. 16, 2008

Related U.S. Application Data
(63) Continuation-in-part of application No. 10/792,627, filed on Mar. 2, 2004.

(51) Int. Cl. G09B 19/00

(52) U.S. Cl. 434/96

(57) ABSTRACT

A multi-faced object with different designs on each face. Each design on each face of the multi-faced object is aligned with the design on an adjacent face of the multi-faced object and when multiples of the multi-faced objects are put together, continuous and seamless patterns are created.

### CROSS-REFERENCE TO RELATED APPLICATION

This application is a continuation in part of application Ser. No. 10/792,627 filed on Mar. 2, 2004.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to a multi-faced object, such as a cube, with various designs. Each face of the multi-faced object contains a design in which a design on one face of the multi-faced object is aligned with a design on an adjacent face of the multi-faced object and when multiples of the multi-faced objects are put together, continuous and seamless patterns are created.

A variety of puzzles and games have been developed in the past. For example, U.S. Pat. No. 3,643,956 to Bovasso discloses a game that can be played with square members, which may be cards or blocks, disposable upon a playing board having squares defined thereon. Each card or block has an identical pattern comprising markings achieving equal divisions upon the sides of the square. Contrasting colors define the pattern, wherein each color occupies an identical portion of each side of the square and any terminus of any marking will meet and mate with any other terminus of a like colored marking on any other member. The purpose of the game is to generate, by the sequential placement of said squares, either a continuity of pattern from one side of the playing board to another side of the playing board, or the completion of a circuit, i.e., an endless track or path, anywhere on the board.

U.S. Pat. No. 4,180,271 to McMurchie discloses a game and game apparatus. The game apparatus comprises a game board, a plurality of cards or the like which are deployed on said game board and a plurality of identifier playing pieces. Each card has a plurality of line segments marked thereon. Each end of the line segments on a card extends to an edge of the card. The line segments on each card or the like are generally curved line segments or straight lines. The playing area of the game board is divided into a plurality of quadrangles, preferably squares, having the same size as the size of the cards. The object of the game is for each player to form a continuous line without having both ends of the line terminate at an edge of the play area of the game board.

U.S. Pat. No. 5,692,749 to Vogeler discloses a tiling, pattern-matching puzzle having a large number of distinct, challenging solutions while maintaining in each solution an overall unity and perceptible wholeness. This is achieved by providing each puzzle piece with a surface design comprising a number of distinct regions separated by contour lines terminating at precisely spaced points along the edges of the piece.

However, unlike the prior arts, the present invention is a multi-faced object with different designs on each face. The different designs are created such that a line from a design on one face continues to lines on a design of an adjacent face.

### SUMMARY

The present invention is a multi-faced object with different designs on each face of the multi-faced object. The line of a design on one face aligns with a line of a design on an adjacent face of the multi-faced object. When multiples of the multi-faced objects are put together, continuous and seamless patterns are created. Using the multi-faced object of the present invention, a system for generating patterned configurations can be created.

### BRIEF DESCRIPTION OF THE FIGURES

FIG. 1 illustrates the multi-faced object of the present invention.

FIG. 2 is a design on a face of the multi-faced object of the present invention.

FIG. 3 is another design on another face of the multi-faced object of the present invention.

FIG. 4 is another design on another face of the multi-faced object of the present invention.

FIG. 5 is another design on another face of the multi-faced object of the present invention.

FIG. 6 is another design on another face of the multi-faced object of the present invention.

FIG. 7 is another design on another face of the multi-faced object of the present invention.

FIG. 8 are the six designs on the various faces of the multi-faced object where the designs are curved.

FIG. 9 are the six designs on the various faces of the multi-faced object where the designs are linear.

FIG. 10 are some of the patterns that can be made with multiples of the multi-faced objects of the present invention.

### FIGURES—REFERENCE NUMERALS

100—Multi-faced Object
200—First Face
250—First Side of first face
260—Second Side of first face
270—Third Side of first face
280—Fourth Side of first face
300—Second Face
350—First Side of second face
360—Second Side of second face
370—Third Side of second face
380—Fourth Side of second face
400—Third Face
450—First Side of third face
460—Second Side of third face
470—Third Side of third face
480—Fourth Side of third face
500—Fourth Face
550—First Side of fourth face
560—Second Side of fourth face
570—Third Side of fourth face
580—Fourth Side of fourth face
600—Fifth Face
650—First Side of fifth face
660—Second Side of fifth face
670—Third Side of fifth face
680—Fourth Side of fifth face
700—Sixth Face
750—First Side of sixth face
760—Second Side of sixth face
770—Third Side of sixth face
780—Fourth Side of sixth face

### DETAILED DESCRIPTION

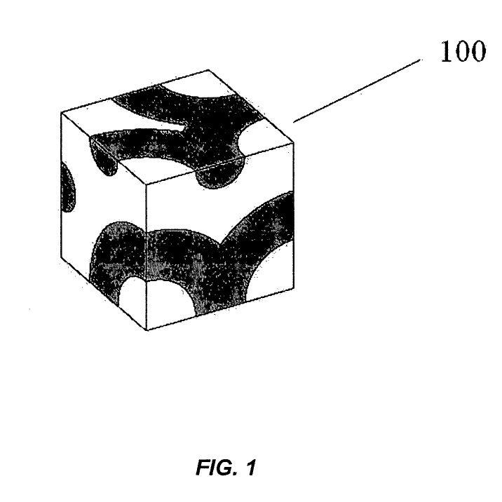

Referring to the drawings, preferred embodiments of the system of the present invention are illustrated in FIGS. 1 through 7. FIG. 1 shows the multi-faced object 100 of the present invention, such as a cube, with designs on each face of the multi-faced object 100. Each of the designs on the multi-faced object 100, shown and discussed in the present invention, are drawn such that the center of the terminus, or part of the designs touching the side of a face, of the designs on each face aligns with the center point of the side to which the design terminates. Additionally, the terminus of a design on one face will align with a terminus of a design on a second face. The terminus are also the same distant from the corners of the multi-faced object 100 such that when the designs are aligned, continuous patterns are formed. A preferred embodiment of the multi-faced object 100 of the present invention is to have the width of the terminus of one design equal to the width of the terminus of the designs on the other faces of the multi-faced object 100. A design ⅓ the size of the side of the face is ideal.

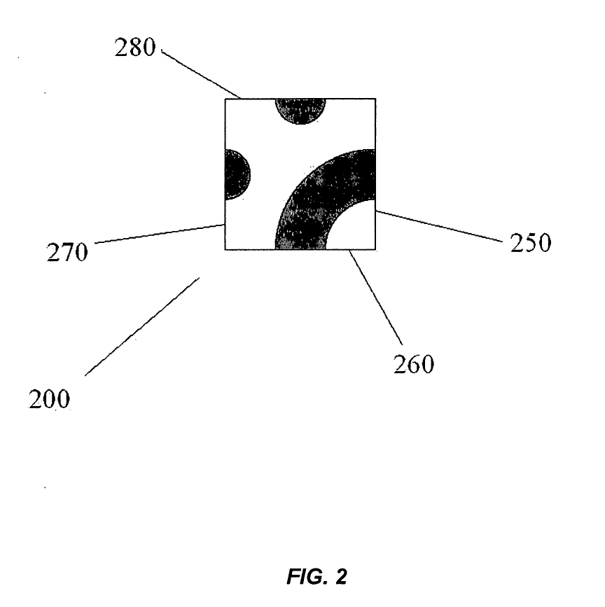

Referring to FIG. 2, a first face 200 is shown with a design that starts from side 250 and ends at side 260. A second design is drawn on side 270 of first face 200. A third design is also drawn on side 280 of first face 200.

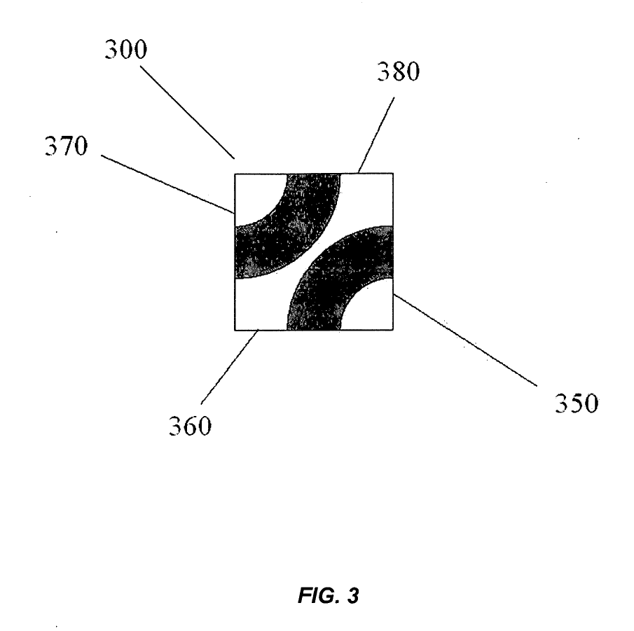

Referring to FIG. 3, second face 300 has a first design beginning on first side 350 and connecting to the adjacent second side 360. A second design begins on third side 370 and connects to adjacent fourth side 380.

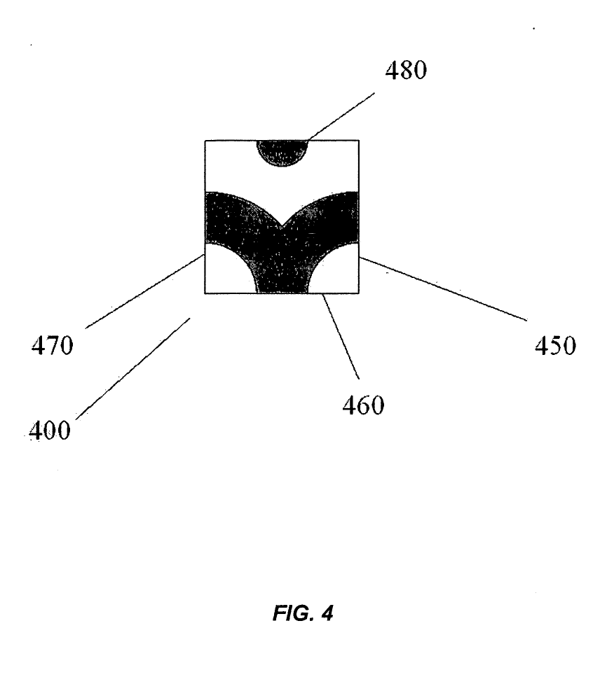

Referring to FIG. 4, third face 400 has a first design beginning on first side 450 and connecting to the adjacent second side 460. A second design begins on second side 460 and connects to adjacent fourth side 470. A third design is also drawn on fourth face 480.

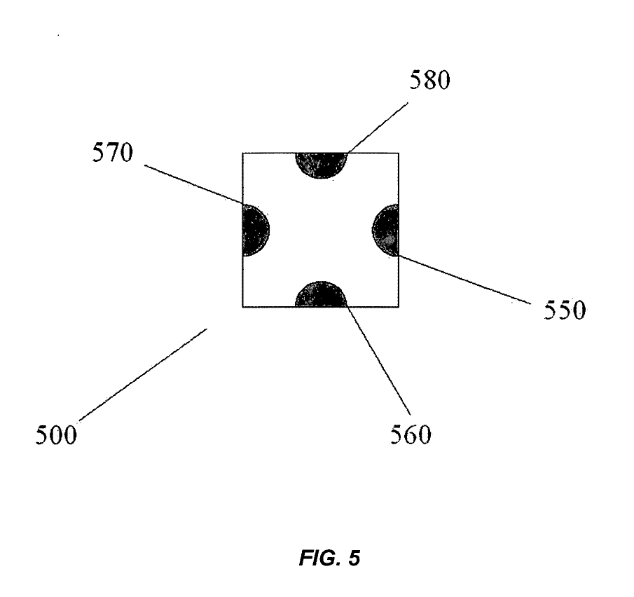

Referring to FIG. 5, fourth face 500 contains a first design on first side 550, a second design on second side 560, a third design on third side 570, and a fourth design on fourth side 580.

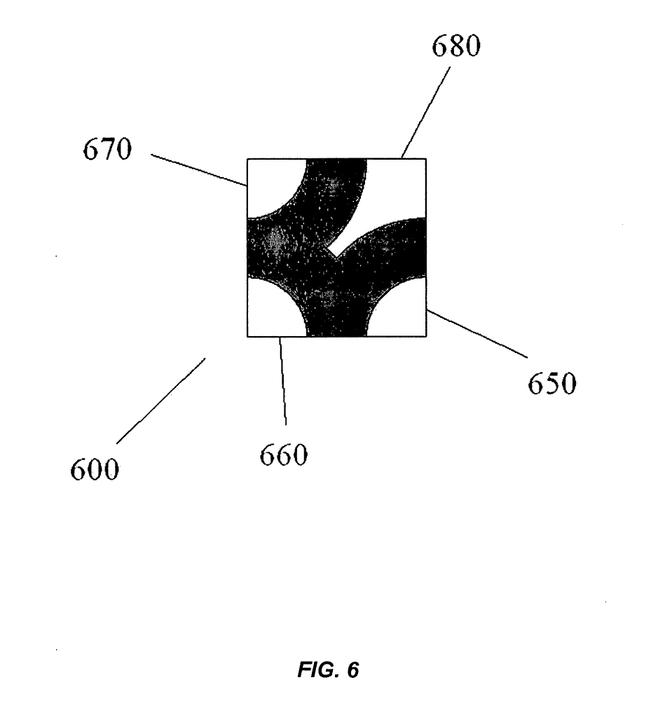

Referring to FIG. 6, fifth face 600 has a first design beginning on first side 650 and connecting to the adjacent second side 660. Fifth face 600 further comprises a second design beginning on second side 660 of fifth face 600 and connecting to adjacent third side 670 of fifth face 600. Fifth face 600 comprises a third design beginning on third side 670 of fifth face 600 and connecting to adjacent fourth side 680 of fifth face 600.

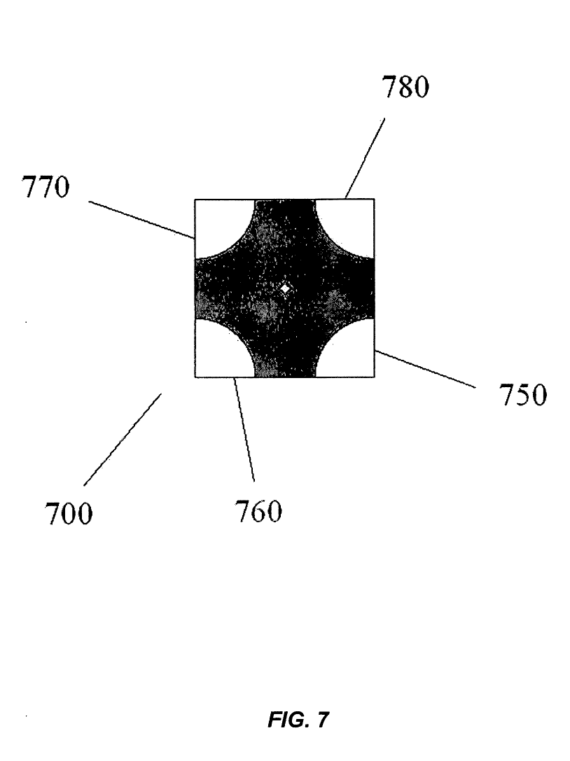

Referring to FIG. 7, sixth face 700 has a first design beginning on first side 750 and connecting to adjacent second side 760. Sixth face 700 comprises a second design beginning on second side 760 of sixth face 700 and connecting to adjacent third side 770 of sixth face 700. A third design is also shown on sixth face 700 beginning on third side 770 of sixth face 700 and connecting to adjacent fourth side 780 of sixth face 700. Sixth face 700 further comprises a fourth design beginning on fourth side 780 of sixth face 700 and connecting to adjacent first side 750.

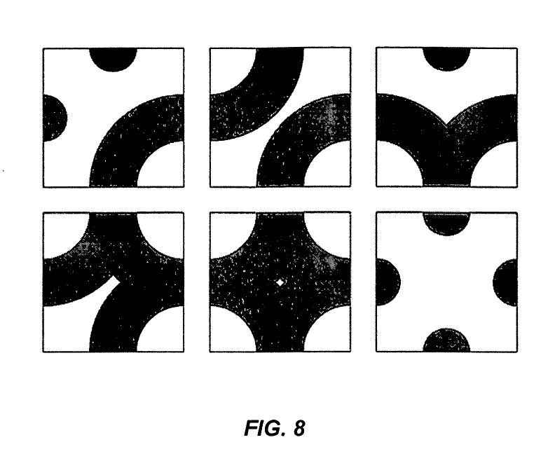

In FIGS. 2 through 7, the designs on the faces of the multi-faced object 100 of the present invention are curved. FIG. 8 shows all six designs on the faces of the multi-faced object 100. The designs used on the faces of each of the multi-faced object 100 can be broken down into two basic shapes, a half-circle and an arc. Different numbers of arc and half-circle are combined to obtain the different design on the faces of the multi-faced object 100.

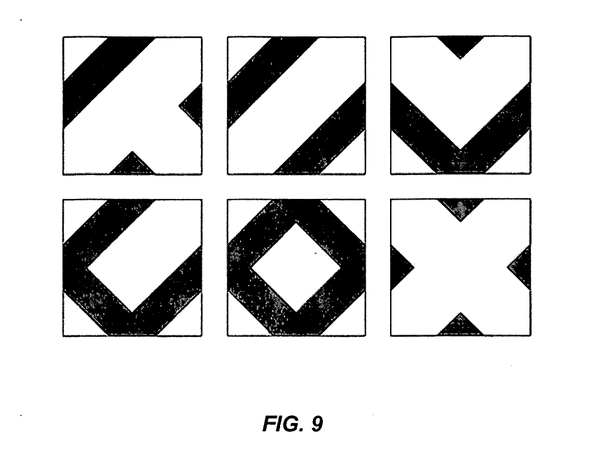

FIG. 9 shows the designs on the faces of the multi-faced object 100 as linear. Other designs may be used as long as the terminus of the designs on each face are drawn such that the center of the terminus, or part of the designs touching the side of a face, of the designs on each face aligns with the center point of the side to which the design terminates. Additionally, the terminus of a design on one face will align with a terminus of a design on a second face. The terminus are also the same distant from the corners of the multi-faced object 100 such that when the designs are aligned, continuous patterns are formed.

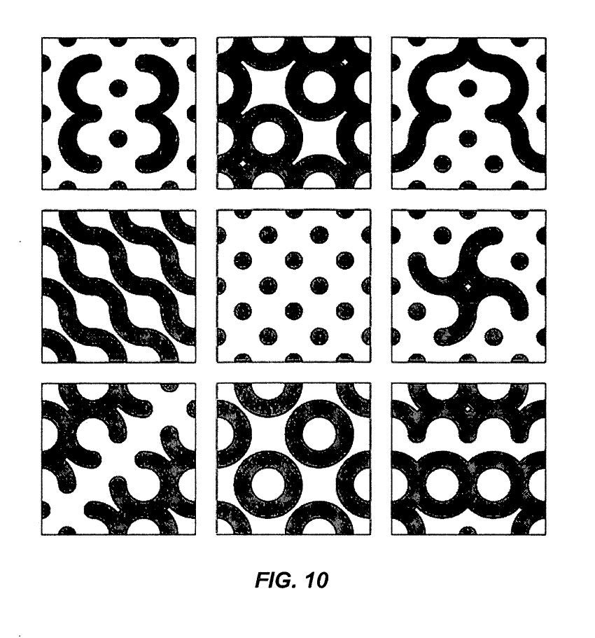

FIG. 10 shows use of the multi-faced object of the present invention to create different patterns. Samples of some of the patterns that may be created with nine of the multi-faced objects of the present invention are shown.

The designs used on the faces of the multi-faced object 100 of the present invention may also be applied to flat surfaces such as tiles. The flat surfaces could then be used to create designs similar to those that are created with the multi-faced object 100.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A multi-faced object comprising:
Design on one face of the multi-faced object which aligns with design on an adjacent face of the multi-faced object.

2. A multi-faced object of claim 1, wherein a center of a terminus of the design aligns with a center of a side of one of the face of multi-faced object.

3. The multi-faced object of claim 1, wherein the object is a cube.

4. The multi-faced object of claim 1, wherein multiples of the multi-faced designs when placed together forms continuous patterns.

5. The multi-faced object of claim 1, wherein the designs are created using arcs and half-circles.

6. The multi-faced object of claim 1, wherein the designs are linear.

7. The multi-faced object of claim 1, wherein the designs are curved and linear.

8. The multi-faced object of claim 1, further comprising:
A first face with a design beginning on a first side of the first face and connecting to an adjacent second side of the first face;
A second design on a third side of the first face;
A third design on a fourth side of the first face;
A second face with a design beginning on a first side of the second face and connecting to an adjacent second side of the second face;
A second design with a design beginning on a third side of the second face and connecting to an adjacent fourth side of the second face;
A third face with a design beginning on a first side of the third face and connecting to a second side of the third face;
A second design beginning on the second side of the third face and connecting to the third side of the third face;
A third design on a fourth side of the third face;
A fourth face with a design on a first side of the fourth face;
A second design on a second side of the fourth face;
A third design on a third side of the fourth face;
A fourth design on a fourth side of the fourth face;
A fifth face with a design beginning on a first side of the fifth face and connecting to an adjacent second side of the fifth face;
A second design beginning on the second side of the fifth face and connecting to an adjacent third side of the fifth face;
A third design beginning on the third side of the fifth face and connecting to an adjacent fourth side of the fifth face;
A sixth face with a design beginning on a first side of the sixth face and connecting to an adjacent second side of the sixth face;
A second design beginning on the second side of the sixth face and connecting to an adjacent third side of the sixth face;
A third design beginning on the third side of the sixth face and connecting to an adjacent fourth side of the sixth face;
A fourth design beginning on the fourth side of the sixth face and connecting to the adjacent first side of the first face.

9. The multi-faced object of claim 8, wherein centers of terminus of the designs aligns with centers of the sides of the faces of the multi-faced objects to where the designs terminate.

10. Use of multi-faced object with patterns comprising:
Multiples of a multi-faced object of the present invention for creating patterns.

11. The use of the multi-faced object of claim 10, wherein designs on faces of the multi-faced objects are curved designs.

12. The use of the multi-faced object of claim 11, wherein shapes used to create the curved designs are arcs and half-circles.

13. The game of claim 11, wherein the designs on faces of the multi-faced objects are curved and linear designs.

14. A system for forming decorative designs, comprising:
Designs where center of terminus of the decorative designs aligns with center of sides to which the designs terminates.

15. A system for forming decorative designs of claim 14, wherein the objects on which the designs are drawn are tiles.

16. A system for forming decorative designs of claim 15, wherein the objects on which the designs are drawn are square.

17. A system for forming decorative designs of claim 16, wherein designs have terminus touching all four sides of the square.

18. A system for forming decorative designs of claim 17, wherein multiple designs have terminus on each side of the object.
